(19) United States
(12) Patent Application Publication
(10) Pub. No.: US 2006/0141427 A1
(43) Pub. Date: Jun. 29, 2006

(54) Adjustable geometric square

(76) Inventor: Al Harrigan, Hanmer (CA)

Correspondence Address: MIKE M. GAUTHIER, 190 CHURCH STREET, GARSON, ON, P3L 1A8, CA

(21) Appl. No.: 11/020,682

(22) Filed: Dec. 27, 2004

(51) Int. Cl. G09B 23/04; G09B 23/02

(52) U.S. Cl. 434/211; 33/429

(57) ABSTRACT

A geometric drawing tool relating to rulers, compasses, protractors etc is provided. In particular the present invention depicts a device for adjustably drawing perfect squares of any size within the device's span. The square comprises: two generally “L” shaped members each having an elongated opening within each arm wherein the long edges of these elongated openings have one smooth edge and one toothed edge. Both “L” shaped members overlap each other at the tips to form a square shape, and are held together with a gear, which meshes with the toothed inner edge of an elongated opening within said overlapped arms, thus forming a rack and pinion arrangement. As the “L” shaped member's centers are drawn toward each other, the inner square proportionately reduced in size, ready to trace.

### FIELD OF THE INVENTION

The present invention relates to a geometric drawing tool as in rulers, compasses, protractors etc. In particular the present invention depicts a device for adjustably drawing perfect squares of any size within the device's span. The square comprises: two generally “L” shaped members each having an elongated opening within each arm wherein the long edges of these elongated openings have one smooth edge and one toothed edge. Both “L” shaped members overlap each other at the tips to form a square shape, and are held together with a gear, which meshes with the toothed inner edge of the elongated opening within said overlapped arms, thus forming a rack and pinion arrangement. As the “L” shaped member's centers are drawn toward each other, the inner square proportionately reduced in size, ready to trace.

### BACKGROUND OF THE INVENTION

School children and adults alike are provided with many tools that help them trace various geometric shapes and angles. Tools like the compass: to trace perfect circular lines, the triangle; to trace and measure pitches, and the protractor; to measure angles, yet no tool is available to make full perfect squares of adjustable sizes.

The inventor sought to provide society, especially school children with a device that enables the user to draw full perfect squares of adjustable sizes.

The applicant has sought to uncover attempts in prior art, that provide means of drawing full perfect squares of adjustable sizes in a small portable tool.

No such art could be found.

### SUMMARY OF THE INVENTION

It is thus the object of the present invention to provide users with a portable easy to use geometric drawing square that is fully adjustable from zero-to the span of said square.

In one aspect of the invention, the size of the square may be adapted to the intended use.

In another aspect of the invention, the material choice for fabrication may be thermoplastic resin, metal or any suitable composite.

In another aspect of the invention, a larger-scale version of the present invention could be made to collapse for ease of transporting.

Accordingly, the device of the present invention therefore provides users with a portable geometric drawing square that is fully adjustable, portable and easy to use.

The utility of the present invention includes but is not limited to geometric squares.

### BRIEF DESCRIPTION OF THE DRAWINGS

These and other advantages of the invention will become apparent upon reading the following brief description and upon referring to the drawings in which:

FIG. 1 is a perspective view from above of adjustable geometric square of the present invention.

FIG. 2 is a top plan view of the adjustable geometric square of the present invention in an expanded state.

FIG. 3 is a top plan view of the adjustable geometric square of the present invention in a semi-collapsed state.

FIG. 4 is a front elevation view of the adjustable geometric square of the present invention.

FIG. 5 is a right side elevation view of the adjustable geometric square of the present invention.

FIG. 6 is a cross-sectional view taken along arrows 6-6 from FIG. 5 of the adjustable geometric square of the present invention.

FIG. 7 is a cross-sectional view taken along arrows 7-7 from FIG. 3 of the adjustable geometric square of the present invention.

FIG. 8 is a cross-sectional view taken along arrows 8-8 from FIG. 3 of the adjustable geometric square of the present invention.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

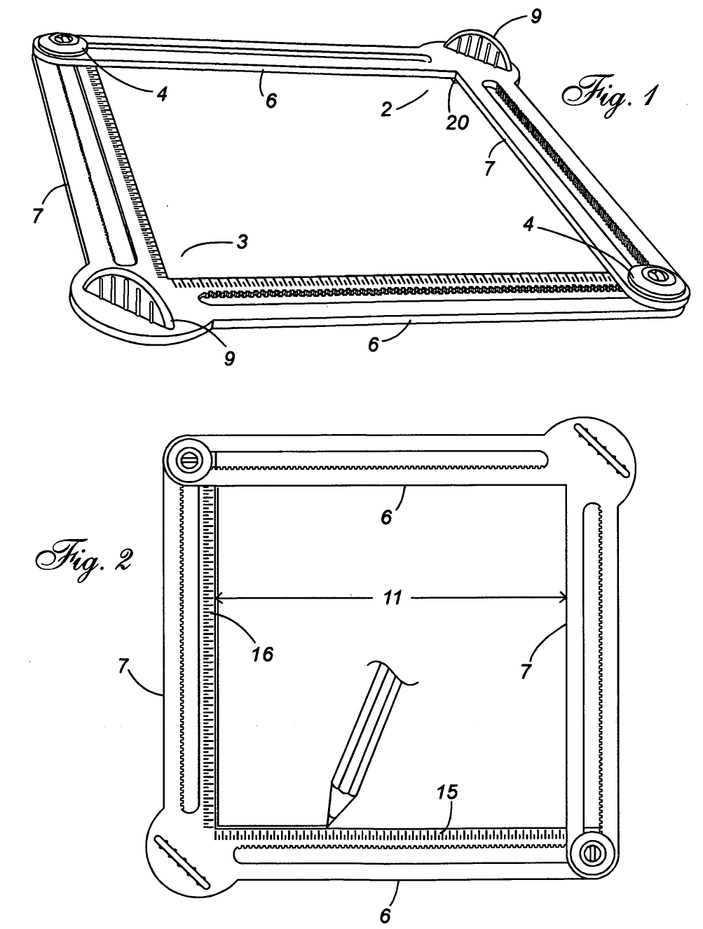

Turning to FIG. 1, a perspective view from above the adjustable geometric square of the present invention comprising; an upper “L” shaped member 2, a lower “L” shaped member 3, and two pinion gear assemblies 4. The upper “L” shaped member comprises; a first 6 and a second 7 arm exactly perpendicular to each other, each said arm having an elongated opening therethrough wherein the long inner edge of the first arm's 6 opening is toothed, and the adjacent outer edge of the same opening is straight and smooth, while the long inner edge of the second arm 7 perpendicular to said first arm 6 of the same member 2 is straight and smooth and the adjacent outer edge of the same opening is toothed. A gear assembly 4 slidably joins the first arm 6 of the upper member 2 with the second arm 7 of the lower member 3, and another gear assembly 4 also joins the second arm 7 of the upper member 2 with the first arm 6 of the lower member 3 thus forming a perfect square. Each “L” shaped member 2 and 3 is adapted with a grip 9 diagonally and integrally disposed onto the upper central surface of said “L” shaped member 2 and 3 thereby providing user with handles to draw and extend the members 2 and 3 toward and away from each other so as to increase and decrease the square's inner dimension. Dimension indicia are provided by means of markings 15 and 16 at the inner edges of the lower “L” shaped member's 3 arms 6 and 7 wherein one edge may consist of imperial measures while the opposing edge may metric measures. A slider 20 of a height equal to the thickness of the lower member 3 is provided so as to planarly level the central portion of the upper member 2.

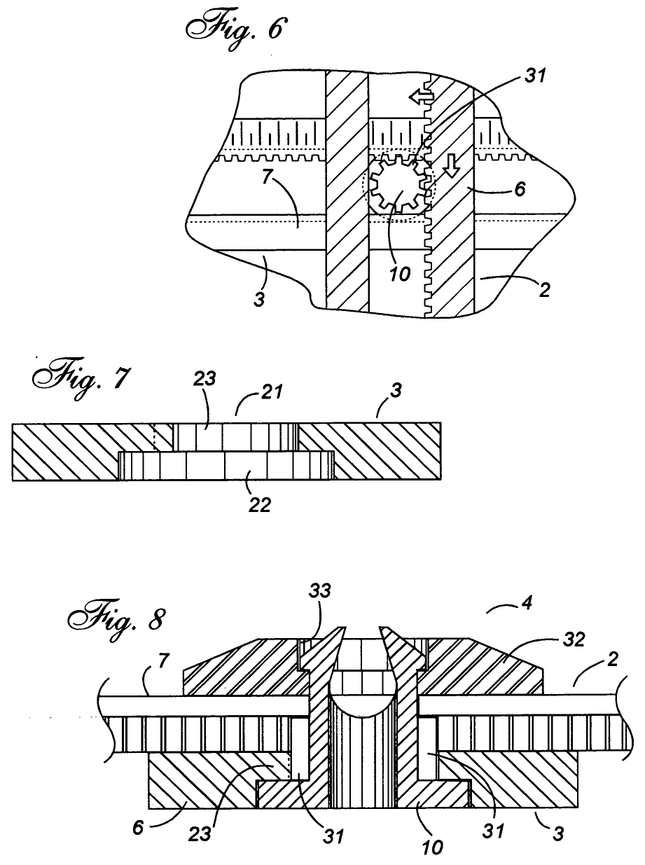

For clarity, let's turn to FIG. 6, a cross-sectional view taken along arrows 6-6 of FIG. 5 wherein the rack and pinion arrangement can be better understood, illustrating the upper member 2 overlapping the lower member 3, and a gear 10 having radially arranged teeth 31 meshes with the toothed edges of both first arm 6 of the upper member 2 and the second arm 7 of the lower member 3. Accordingly, from this point of view, a lateral motion applied to the left of the upper member 2 will automatically and proportionately generate a motion toward the user of said upper member 2 effectively resulting in a diagonal motion. This applied to both slidably intersecting sets of arms results in the increasing and decreasing of dimension within the square formed by the adjustable geometric square of the present invention.

Returning now to FIG. 2, a top plan view of the adjustable geometric square of the present invention in an expanded state where it can be seen that the inner geometric square's maximum dimension 11 is only limited by the span of the arms 6 & 7, which can be fabricated to suit virtually any application. Dimension indicia are provided onto the inner top surface of the lower member's 3 arms 6 and 7.

FIG. 3, again a top plan view of the adjustable geometric square of the present invention in a semi-collapsed state wherein when a small diagonal force 12 is inwardly applied to each upper 2 and lower member 3. User simply applies downward pressure on both members 2 and 3 and traces a perfect square of the desired size.

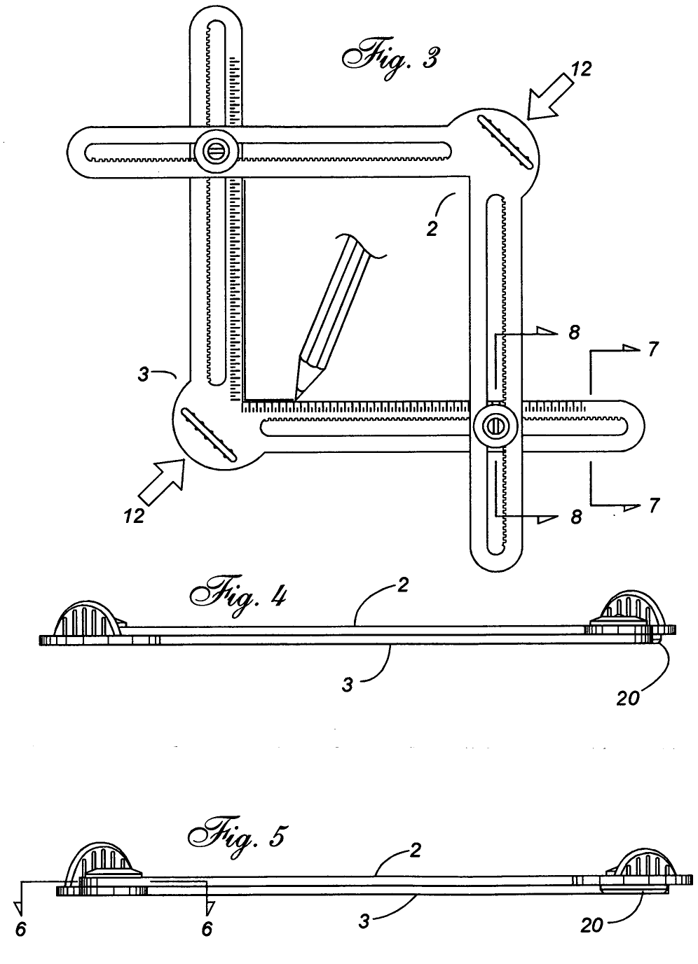

Turning to FIGS. 4 and 5, FIG. 4, a front elevation view, and FIG. 5, a right side elevation view of the adjustable geometric square of the present invention illustrating the overlapping arrangement of the upper 2 and lower 3 members wherein since the upper member 2 is elevated from a surface, a slider 20 is provided to raise the central portion of the upper member 2 a distance equal to the thickness of the lower member 3 so as to maintain a level plane for the upper member 2.

Referring now to FIG. 7, a cross-sectional view taken along arrows 7-7 from FIG. 3 of the second arm 7 of the lower member 3 of the present invention wherein the profile at the opening 21 is such that the lower portion 22 is wider that the upper portion 23, and that only the upper portion 23 of the opening 21 is toothed.

Turning now to FIG. 8, a cross sectional view taken along arrows 8-8 from FIG. 3, illustration in more detail the gear assembly 4 wherein the first arm 6 of the lower member 3 intersects and overlaps with the second arm 7 of the upper member 2. The upper half 23 of the lower member 3 is toothed on one edge while the lower half 22 of same member 3 opening is smooth-edged and slightly wider than the upper half opening 23. The gear 10 further comprises: a lower disk shaped portion having a diameter greater than a toothed portion 31 above said disk, a retainer clip 33 integral atop said toothed portion 31 so as to slidably hold together the upper and lower “L” shaped members 2 and 3 via the gear assembly 4.

Upon referring to the drawing figures and the above specification, it can be understood that the adjustable geometric square of the present invention provides the user with a simple to use, lightweight, portable and adjustable geometric square for tracing of perfect squares onto a flat surface.

What I claim as my invention:

1. An adjustable geometric square comprising:
i. a lower “L” shaped member,
ii. an upper “L” shaped member,
iii. gear assemblies for slidably joining upper and lower “L” shaped members,
iv. grips for manipulating upper and lower “L” shaped members, and
v. dimension indicia means.

2. The adjustable geometric square of claim 1 wherein the “L” form of one member is positioned 180 degrees rotated from the other mating “L” form so as to, when assembled, form a perfect square formation.

3. The adjustable geometric square of claims 1 and 2 wherein the “L” shaped members further comprise: an upper member, and a lower member, overlapping each other at the arms.

4. The adjustable geometric square of claims 1, 2 and 3 wherein each arm of the “L” shaped members has an elongated opening, which one long edge is toothed to mesh with a rotary gear and the opposing edge of said opening is smooth.

5. The adjustable geometric square of claims 1 to 4 wherein a rotary gear meshes with two perpendicularly arranged toothed edge of one each arm of “L” shaped members.

6. The adjustable geometric square of claims 1 and 4 wherein the rotary gear has a lower circular rim extending outwardly from said gear so as to prevent further upward motion of said gear within the elongated opening of the lower “L” shaped member.

7. The adjustable geometric square of claim 1 wherein the gear assembly further comprises a retainer ring having a central circular rabetted perforation through which a flanged upper portion of the gear snaps into so as to slidably hold together the perpendicularly arranged arms of the lower and upper “L” shaped members.

8. The adjustable geometric square of claim 1 wherein a grip is located diagonally atop each central portion of the “L” shaped members so as to provide handle means to manipulate the square.

9. The adjustable geometric square of claim 1 wherein the upper inner edge of the lower “L” shaped member is marked with dimension indicia that indicate the size of the square.

10. The adjustable geometric square of claim 8 wherein the indicia on one arm of the lower “L” shaped member is in Imperial format, and the indicia on the opposing perpendicular arm of the same member is in Metric format.

11. The adjustable geometric square of claims 1 through 10 wherein drawing the grips of both upper and lower “L” shaped members proportionately decreases the size of the perfect square, and pulling apart said grips proportionately increases the size of the said square.

12. The adjustable geometric square of claims 1 through 11 wherein the use thereof is to provide users with a simple to use, lightweight, portable and adjustable geometric square for tracing of perfect squares onto a flat surface.
